(19) United States
(12) Patent Application Publication
(10) Pub. No.: US 2002/0056142 A1
(43) Pub. Date: May 9, 2002

(54) Portable apparatus for providing wireless media access and storage and method thereof

(76) Inventor: Scott D. Redmond, San Francisco, CA (US)

Correspondence Address: PATRICK J S INOUYE P S, 810 3RD AVENUE, SUITE 258, SEATTLE, WA, 98104, US

(21) Appl. No.: 09/753,768

(22) Filed: Jan. 2, 2001

Related U.S. Application Data
(60) Provisional application No. 60/174,309, filed on Jan. 3, 2000.

(51) Int. Cl. H04N 7/173

(52) U.S. Cl. 725/151

(57) ABSTRACT

An apparatus for providing wireless media access and storage and method thereof are described. Data values and program code are stored in a data store in a general purpose memory. The general purpose memory includes a plurality of randomly accessible memory locations. Session-based communication connectivity is provided via a wireless interface with a wireless information service in accordance with a wireless protocol. A user interface is exported. The user interface includes inputs controls receiving user instructions and output channels capable of media playback. A processor is operatively coupled to the data store, the wireless interface, and the user interface. An operating system is executed responsive to user instructions received via the input controls. The data values and the program code maintained in the data store are cooperatively processed. Media content is received via the wireless information service through the wireless interface for transitory storage in the data store. The media content is played on the output channels.

### CROSS-REFERENCE TO RELATED APPLICATION

This patent application claims priority under 35 U.S.C. § 119(e) to provisional patent application Ser. No. 60/174,309, filed Jan. 3, 2000, the disclosure of which is incorporated by reference.

### FIELD OF THE INVENTION

The present invention relates in general to wireless media access and storage and, in particular, to a portable apparatus for providing wireless media access and storage and method thereof.

### BACKGROUND OF THE INVENTION

Television is among the most widely available form of video mass communications in use today. The basic format of television is relatively mature, consisting primarily of transmission stations sending programming signals to passive receivers or “sets.” Program selection is limited to those channels “aired” by licensed broadcasters. Cable- and satellite-based programming have recently introduced limited user-tailorable options, including services such as video-on-demand, using set-top box and telephonic purchasing options.

Television viewing is a static, non-interactive activity. Conversely, online information services, such as available through Internet service providers, offer fully interactive services, including media content storage and retrieval facilities. Most standard personal computer browsers allow a user to select, download, and view audio and video content. As well, “live” content is becoming increasingly available through pulsed, streaming and related media retrieval formats.

Cellular and similar forms of wireless voice communication have begun to expand into the digital data delivery markets. For instance, microbrowsers are being integrated into cellular telephone display panels to enable users to retrieve textual data in an extremely abbreviated format. While interactive, hybrid cellular telephones are limited to conventional textual data content and lack integration with television and video programming.

Therefore, there is a need for an approach to providing portable wireless access to audio and video media that includes a high degree of customizability and user interactivity. Such an approach would preferable include both wireless access and storage means and allow interaction with other non-fixed information sources, such as outdoor media, including billboards and similar informal informational devices.

There is a further need for a flexible approach to remote wireless audio and video access. Such an approach would allow either an integrated or modular wireless connection scheme.

There is a further need for an approach to enabling remote video editing and production on a wireless connected device. Such an approach would preferably include video recordation means, such as using an external digital camera arrangement.

### SUMMARY OF THE INVENTION

The present invention provides a portable, handheld device and method for transacting wireless communications sessions for media retrieval and access. The handheld device includes processing logic to initiate and carry out a wireless communications session with a wireless information service. A user operates the handheld device using input controls and downloaded video and audio media is played back to the user on a display panel.

An embodiment of the present invention is a portable apparatus for providing wireless media access and storage and method thereof. Data values and program code are stored in a data store in a general purpose memory. The general purpose memory includes a plurality of randomly accessible memory locations. Session-based communication connectivity is provided via a wireless interface with a wireless information service in accordance with a wireless protocol. A user interface is exported. The user interface includes inputs controls receiving user instructions and output channels capable of media playback. A processor is operatively coupled to the data store, the wireless interface, and the user interface. An operating system is executed responsive to user instructions received via the input controls. The data values and the program code maintained in the data store are cooperatively processed. Media content is received via the wireless information service through the wireless interface for transitory storage in the data store. The media content is played on the output channels.

Still other embodiments of the present invention will become readily apparent to those skilled in the art from the following detailed description, wherein is described embodiments of the invention by way of illustrating the best mode contemplated for carrying out the invention. As will be realized, the invention is capable of other and different embodiments and its several details are capable of modifications in various obvious respects, all without departing from the spirit and the scope of the present invention. Accordingly, the drawings and detailed description are to be regarded as illustrative in nature and not as restrictive.

### BRIEF DESCRIPTION OF THE DRAWINGS

FIG. 1 is a functional block diagram showing a wireless computing environment, including an apparatus for providing wireless media access and storage in accordance with the present invention.

FIG. 2 is an elevation view showing the front of the apparatus of FIG. 1.

FIGS. 3A and 3B are plan and elevation views, respectively, of the scroll control buttons of the apparatus of FIG. 1.

FIG. 4 is an elevation view showing the back of the apparatus of FIG. 1.

FIG. 5 is a plan view showing the back of the apparatus of FIG. 1 with a plug-in wireless module attached.

FIG. 6 is a schematic diagram showing the functional components of the apparatus of FIG. 1.

FIG. 7 is a flow diagram showing a method for providing wireless media access and storage in accordance with the present invention.

FIG. 8 is a functional block diagram showing a billboard interface.

FIG. 9 is a functional block diagram showing a set top box interface.

FIG. 10 is a functional block diagram showing a client-server video production and editing interface.

### DETAILED DESCRIPTION

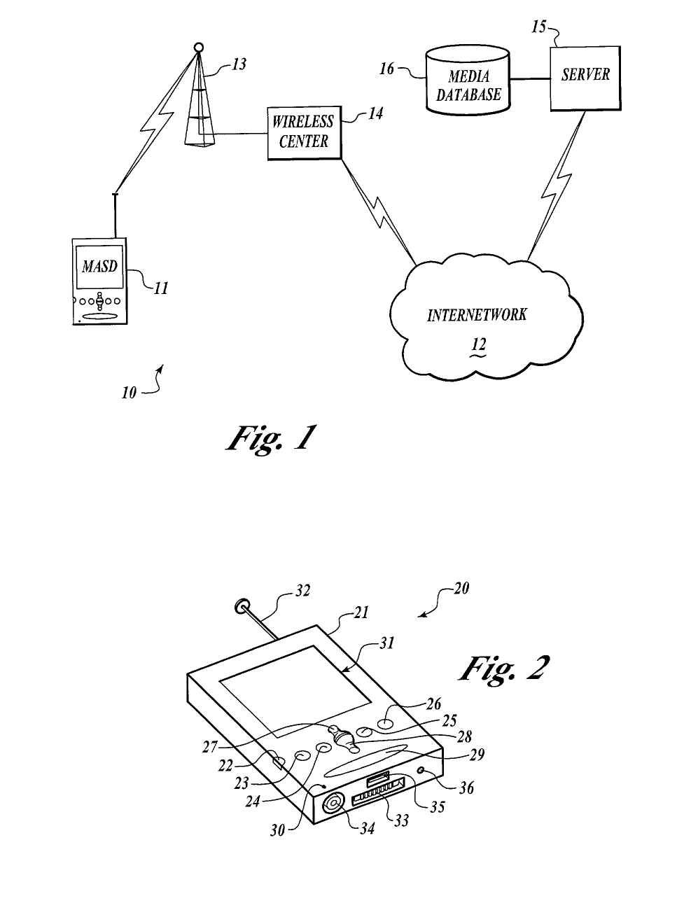

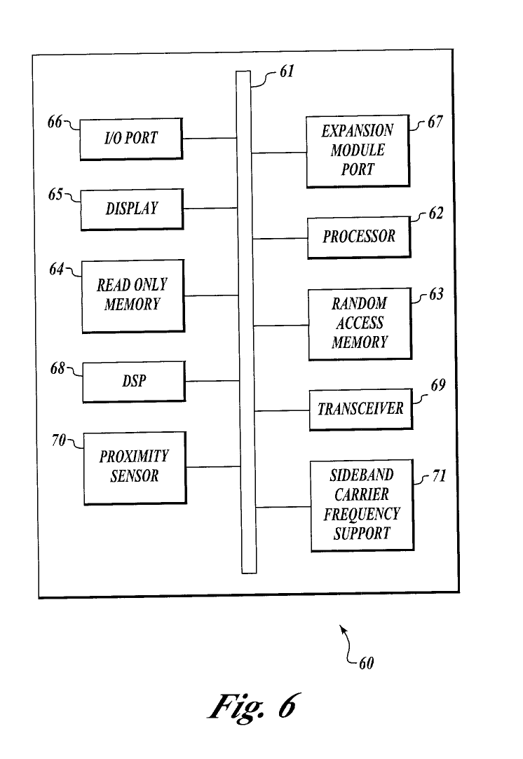

FIG. 1 is a functional block diagram showing a wireless computing environment 10, including an apparatus for providing wireless media access and storage (MASD) 11, in accordance with the present invention. The media access and storage apparatus 11 includes a data store, a wireless interface, a user interface, and a processor, as further described below with reference to FIG. 6. The apparatus 11 initiates and carries out a communications session via the wireless interface through a subscribed wireless information service, such as a cellular telephone connection 13. Preferably, the apparatus 11 is continuously scanning for other similarly equipped systems within the immediate area, as well as for outdoor media, including billboards and similar informal informational devices. Thus, the apparatus 11 is able to automatically detect other compatible devices and can form a mini local area network. The user could then interact with other participating systems. In the described embodiment, the apparatus has a range of approximately 100 feet, although other suitable distances are feasible.

The wireless communications session 13 could also operate over a subscribed wireless data communications network, such as offered by Ricochet wireless data service, offered by Metricom, Inc., San Jose, Calif. Alternatively, the wireless session 13 could be provided via a frequency modulation (FM) radio sideband carrier frequency that would provide a pervasive secondary channel for data exchange. The user could also manually select the FM radio sideband carrier frequency as a primary wireless information service. Finally, the wireless communications session could operate in a dynamically load balanced and pulsed media distribution network using file segmentation, such as described in commonly-assigned U.S. Provisional Patent application Ser. No. ______, entitled “Dynamically Load Balanced And Pulsed Media Distribution Network Architecture,” filed Jan. 2, 2001, the disclosure of which is incorporated by reference.

The wireless session 13 interfaces to a wireless server 14 interconnected to an internetwork 12, such as the Internet, via a conventional high speed network connection. Through the wireless server 14, the apparatus 11 can forward requests for and retrieve media content stored or made available through a conventional server 15. Recorded media content is stored in a media database 16 coupled to the server 15. Alternatively, “live” media content can be retrieved from services offering pulsed, streaming or similar audio or video content delivery.

In the described embodiment, the wireless communications session 13 is transacted in accordance with a standard wireless protocol, such as the Wireless Access Protocol (WAP), Nokia Wireless Protocol, Motorola Wireless Protocol, Lucent signal array standard, Bluetooth protocol, and the IEEE 802.11 standard. Other forms of wireless communications sessions could also be utilized herein, as would be recognized by one skilled in the art.

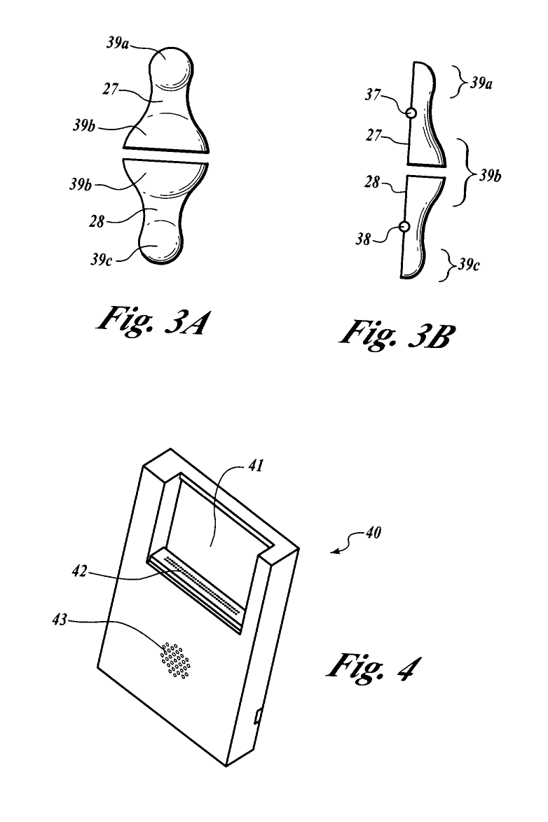

FIG. 2 is an elevation view 20 showing the front of the apparatus 11 of FIG. 1. The apparatus 11 is constructed in a portable, handheld form factor 21 with a plurality of input controls and output channels, preferably having an ornamental design such as described in commonly-assigned U.S. Pat. application Ser. No. ______, entitled “Wireless Media Access And Storage Apparatus,” filed Jan. 2, 2001, pending, the disclosure of which is incorporated by reference. A power switch 22 controls the operation of the apparatus 11. A set of control buttons 23-26 respectively initiate the scheduling, contact management, menu selection, and notation functions. An option control button 29 activates a user option selection menu. Pressing each control button 23-26 causes the execution of an associated application, the results of which are displayed on a screen display 31.

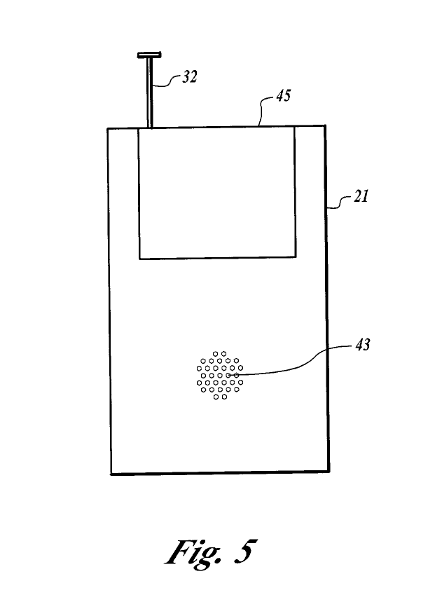

In addition, a pair of “Up” and “Down” scroll control buttons 27, 28, respectively, allow a user to vertically scroll through the contents of a screen display 31. As shown with reference to FIGS. 3A and 3B, the “Up” scroll control button 27 toggles along a transverse pivot 37 to allow dual actuation motion. Similarly, the “Down” scroll control button 28 toggles along a transverse pivot 38 to also allow dual actuation motion. A set of domed surfaces 39a-c on each end of the “Up” and “Down” scroll control buttons 27, 28 aid a user in selecting a toggle action. In the described embodiment, pressing the “Up” scroll control button 27 on the first domed surface 39a causes an upward screen scrolling action while pressing the “Down” scroll control button 38 on the third domed surface 39c causes a downward screen scrolling action. Pressing the second domed surface 39b on both buttons activates a main menu. Returning to FIG. 2, audio inputs can be received through a pinhole microphone 30 for recordation and processing and played back through a speaker (shown in FIG. 5). Video can be received and sent through a composite, preferably RCA-style, video port 34. Serial devices can interconnect to the apparatus 11 via a Universal Serial Bus (USB) port 35. Finally, audio can be output through a mini stereo jack 36. Other arrangements of communications and data ports are feasible.

The apparatus 11 can be docked to a base station using a docking port 33. The individual docking pins preferably back slide into the housing of the apparatus 11 to reveal full length, thin PCB modules.

Finally, in the described embodiment, the apparatus 11 is configured with a plug-in wireless module (shown in FIG. 5) that includes a telescoping (or fixed) antenna 32.

FIG. 4 is an elevation view showing the back 40 of the apparatus 11 of FIG. 1. The apparatus 11 includes a modular expansion port 41 with a plurality of connection pins 42. The modular expansion port 41 allows flexible addition of function modules, such as a plug-in wireless module, as further described below with reference to FIG. 5. The connection pins 42 can be via a proprietary arrangement or in conformity with industry standard practice. The apparatus 11 also includes a speaker 43, preferably consisting of a pizzo electric element, with which to reproduce recorded sound.

In the described embodiment, a plug-in wireless module 45 is fitted into a modular expansion port 41 on the apparatus 11 to provide wireless communications capabilities as shown with reference to FIG. 5. The wireless module 45 preferably includes a flat telescoping flat antenna 32. Different wireless modules 45 are employed, depending on the wireless protocol employed. In an alternate embodiment (not shown), a conventional cellular telephone adapter cable is connected between the docking port 33 (shown in FIG. 2) and a cellular telephone to enable the apparatus 11 to directly transact a wireless communications session.

FIG. 6 is a schematic diagram 60 showing the functional components of the apparatus 11 of FIG. 1. The apparatus 11 consists of ten principal components interconnected over a common bus 61. For simplicity, power supply components have been omitted for clarity, although one skilled in the art would recognize that a power supply and similar functional elements would necessarily be included as part of an actual implementation.

A processor 62 executes program code responsive to user instructions received via the input controls 23-27 (shown in FIG. 2). The program code and data values are stored in a random access memory (RAM) 63 consisting of dynamic random memory integrated circuit components. The operation of the apparatus 11 is controlled by an operating system and a library of support functions stored in a read only memory (ROM) 64. The ROM 64 also includes a serial number to uniquely identify the apparatus 11 for use in automatic recognition and participation with outdoor media and similar informal informational devices, as further described below with reference to FIG. 6.

As described, the processor 62 operates at 166 MHz or faster and the RAM 63 and ROM 64 have capacities of eight megabytes and sixteen megabytes, respectively. The RAM 63 can preferably be configured to store up to twelve minutes of video. The RAM 63 can include memory configurations including Smart Card, Smart Media, Compact Flash, Memory Stick, and conventional RAM IC technology, as well as other arrangements, topologies, and configurations. A rechargeable battery, such as a lithium cell, is provided.

In addition to the core functionality provided by the processor 62 and RAM 63 and ROM 64, several additional components augment the apparatus 11 with media access and storage capabilities. A display 65 capable of providing media playback is coupled to the processor 62, preferably supporting a color display with a minimum resolution of 320×240 pixels and thousands of colors. A black and white or grayscale display could also be used.

In addition, circuitry for input and output (I/O) ports 66, the expansion module port 67, a digital signal processing (DSP) chip 68, a transceiver 69, a proximity sensor 70, and FM radio sideband carrier frequency support 71, are also coupled to the processor 62.

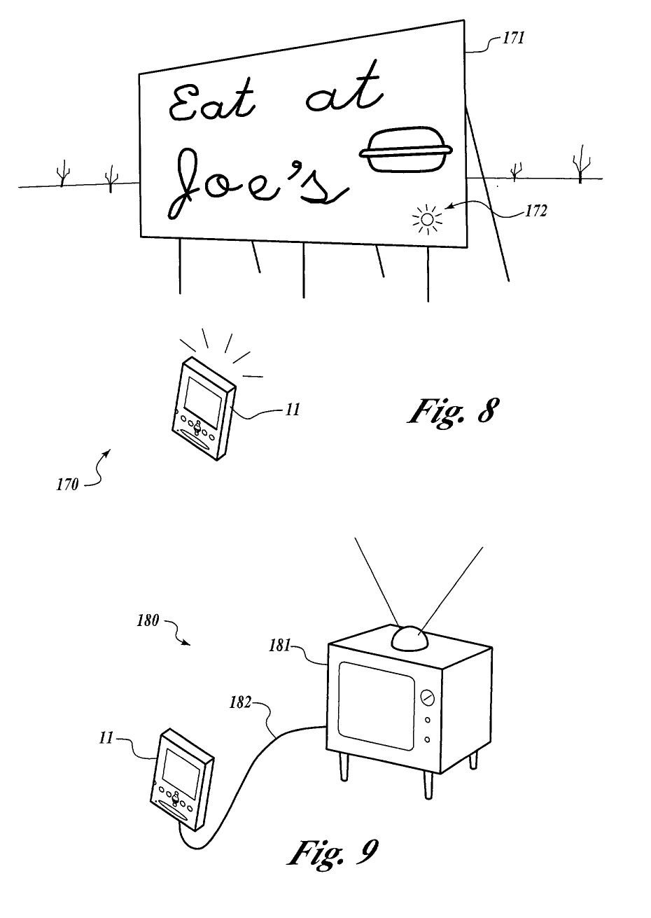

In the described embodiment, the I/O ports 66 include a Universal Serial Bus (USB) port and proprietary docking pins configured to allow the apparatus 11 to dock into a downloading station (not shown). These docking pins allow information stored in the RAM 63 to be retrieved and modified and the ROM 64 to be reprogrammed. The DSP chip 68 is used to process retrieved media, particularly audio and video media. The transceiver 69 allows the apparatus 11 to transact a wireless communications session with a remote wireless device. The proximity sensor 70 and transceiver 69 cooperatively enable the apparatus 11 to recognize and initiate a communications session with other compatible devices, including similarly equipped systems, SmartCards, outdoor media and similar informal informational devices, as further described below with reference to FIG. 8. Finally, FM radio sideband carrier frequency support 71 is provided to allow communication over a secondary communications channel.

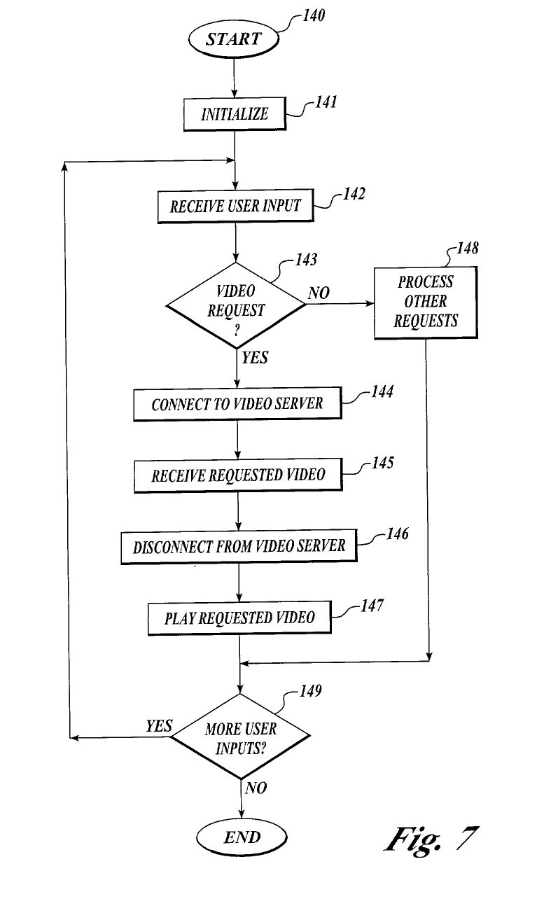

FIG. 7 is a flow diagram showing a method 140 for providing wireless media access and storage in accordance with the present invention. The primary function of apparatus 11 is to access and store media, particularly video media. The apparatus 11 operates under the control of an embedded operating system which, in the described embodiment, is based on the Palm operating system, licensed by Palm, Inc., Santa Clara, Calif.

The apparatus 11 first initializes by loading the operating system (block 141). Next, user requests received via the control buttons 23-27 (block 142), are iteratively processed, as follows. If the request is a video request (block 143), the apparatus 11 initiates a wireless communications session with a video server (block 144) and requests the video. The requested video is received (block 145) by a data stream or similar downloading process, after which the wireless communications session is disconnected (block 146). Finally, the video is played on the screen display 29 (block 147). Alternatively, if the request is not a video request (block 142), the request is processed (block 148), as appropriate. The iterative processing loop (blocks 142-148) is repeated as long as more user requests are presented (block 149), after which the method terminates.

FIG. 8 is a functional block diagram showing a billboard interface 170. The proximity sensor 70 and FM radio sideband carrier frequency support 71 (shown in FIG. 6) enable the apparatus 11 to automatically detect SmartCard and outdoor media devices and to initiate a wireless communications session. In the described embodiment, a billboard 171 is equipped with an emitter 172, preferably operating on a FM radio sideband carrier frequency. The billboard 171 is optionally interfaced via land lines with a dial-up or dedicated network connection.

When within a suitable proximity of the emitter 172 for wireless communication, the apparatus 11 notifies the user who can optionally connect with the billboard 171 and transact a purchase, conduct a dialog, or engage in an interactive session. Alternatively, the billboard 171 could operate as a cellular telephone array or similar wireless carrier. As well, any other form of indoor or outdoor media could be used in lieu of the billboard 171, including a bus kiosk, bus aisle sign, tee shirts, or other forms of advertising or communications.

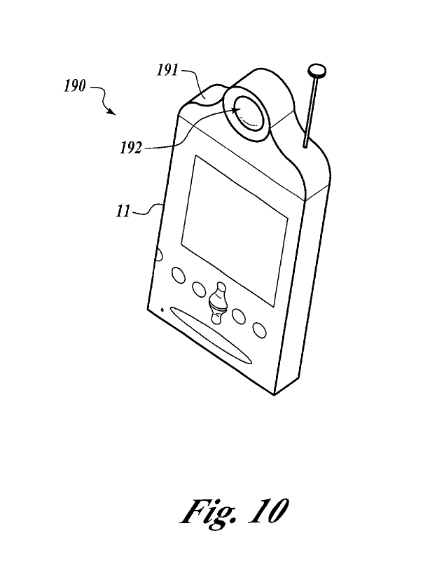

FIG. 9 is a functional block diagram showing a set top box interface 180. Through the composite video port 44 (shown in FIG. 2), the apparatus 11 can function as a wireless video interface to a conventional black and white or color television set 181. A composite video cable 182 interconnects the apparatus 11 to the television set 181 to provide a live video feed for full screen playback.

Finally, FIG. 10 is a functional block diagram showing a client-server video production and editing interface 190. A CMOS camera device 191 can be integrated into the apparatus 11 via the modular expansion port 41 (shown in FIG. 4). The camera device 191 includes a CCD optical pickup with user-operable lens 192. Video recorded by the camera device 191 is stored in the apparatus 11 and can be edited and manipulated with the assistance of the DSP chip 68 (shown in FIG. 6).

While the invention has been particularly shown and described as referenced to the embodiments thereof, those skilled in the art will understand that the foregoing and other changes in form and detail may be made therein without departing from the spirit and scope of the invention.

What is claimed is:

1. A portable apparatus for providing wireless media access and storage, comprising:
a data store storing data values and program code in a general purpose memory comprising a plurality of randomly accessible memory locations;
a wireless interface providing session-based communication connectivity with a wireless information service in accordance with a wireless protocol;
a user interface comprising inputs controls receiving user instructions and output channels capable of media playback; and
a processor operatively coupled to the data store, the wireless interface, and the user interface and including program logic comprising:
an operating system responsive to user instructions received via the input controls to cooperatively process the data values and the program code maintained in the data store; and
media processing logic receiving media content via the wireless information service through the wireless interface for transitory storage in the data store and playing the media content on the output channels.

2. A portable apparatus according to claim 1, wherein the wireless interface further comprises:
a wireless expansion port operatively coupled with the processor; and
a wireless communications module.

3. A portable apparatus according to claim 1, wherein the wireless interface further comprises:
a wireless communications device; and
an external adapter interfacing the portable apparatus to the wireless communications device.

4. A portable apparatus according to claim 1, wherein the wireless protocol is selected from the set comprising at least one of the Wireless Access Protocol (WAP), Nokia Wireless Protocol, Motorola Wireless Protocol, Lucent signal array standard, Bluetooth protocol, the IEEE 802.11 standard, and the frequency modulation sideband carrier frequency standard.

5. A portable apparatus according to claim 1, wherein the media playback operates in accordance with a standard selected from the set comprising at least one of NTSC, composite video, and digital video.

6. A portable apparatus according to claim 1, wherein the data store is selected from the group comprising at least one of a Smart Card, Smart Media, Compact Flash, Memory Stick, and conventional RAM IC technology.

7. A portable apparatus according to claim 1, wherein the program logic further comprises function logic selected from the group comprising performing at least one of:
forming a wireless communications session connection;
purchasing at least one of goods and service;
recognizing a user of the portable apparatus;
interacting with another device;
participating in a wireless communications session;
acquiring information; and
performing at least one of video editing and video production.

8. A portable apparatus according to claim 1, wherein the program logic further comprises:
a data organizer integral to the portable apparatus and performing the functions selected from the group comprising at least one of managing contacts, managing time, and organizing notes.

9. A portable apparatus according to claim 1, wherein the program logic further comprises:
an outdoor media interface interfacing the portable apparatus with an outdoor media display for interactive content exchange.

10. A method for providing wireless media access and storage, comprising:
storing data values and program code in a data store in a general purpose memory comprising a plurality of randomly accessible memory locations;
providing session-based communication connectivity via a wireless interface with a wireless information service in accordance with a wireless protocol;
exporting a user interface comprising inputs controls receiving user instructions and output channels capable of media playback; and
operating a processor coupled to the data store, the wireless interface, and the user interface, comprising:
executing an operating system responsive to user instructions received via the input controls to cooperatively process the data values and the program code maintained in the data store; and
receiving media content via the wireless information service through the wireless interface for transitory storage in the data store and playing the media content on the output channels.

11. A method according to claim 10, wherein the wireless interface further comprises:
a wireless expansion port operatively coupled with the processor; and
a wireless communications module.

12. A method according to claim 10, wherein the wireless interface further comprises:
a wireless communications device; and
an external adapter interfacing to the wireless communications device.

13. A method according to claim 10, wherein the wireless protocol is selected from the set comprising at least one of the Wireless Access Protocol (WAP), Nokia Wireless Protocol, Motorola Wireless Protocol, Lucent signal array standard, Bluetooth protocol, the IEEE 802.11 standard, and the frequency modulation sideband carrier frequency standard.

14. A method according to claim 10, wherein the media playback operates in accordance with a standard selected from the set comprising at least one of NTSC, composite video, and digital video.

15. A method according to claim 10, wherein the data store is selected from the group comprising at least one of a Smart Card, Smart Media, Compact Flash, Memory Stick, and conventional RAM IC technology.

16. A method according to claim 10, wherein the program logic further comprises function logic selected from the group comprising performing at least one of:
forming a wireless communications session connection;
purchasing at least one of goods and service;
recognizing a user;
interacting with another device;
participating in a wireless communications session;
acquiring information; and
performing at least one of video editing and video production.

17. A method according to claim 10, wherein the program logic further comprises:
providing an integral data organizer and performing the functions selected from the group comprising at least one of managing contacts, managing time, and organizing notes.

18. A method according to claim 10, wherein the program logic further comprises:
interfacing with an outdoor media display via an outdoor media interface for interactive content exchange.

19. A computer-readable storage medium holding code for performing the method of claim 10.
